(19) United States
(12) Patent Application Publication
(10) Pub. No.: US 2010/0010847 A1
(43) Pub. Date: Jan. 14, 2010

(54) TECHNIQUE THAT UTILIZES A MONTE CARLO METHOD TO HANDLE THE UNCERTAINTY OF INPUT VALUES WHEN COMPUTING THE NET PRESENT VALUE (NPV) FOR A PROJECT

(75) Inventor: Murray R. Cantor, Cambridge, MA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 12/170,886

(22) Filed: Jul. 10, 2008

(51) Int. Cl. G06Q 10/00

(52) U.S. Cl. 705/7

(57) ABSTRACT

The present invention can include a method for handling the uncertainty of input variables in the calculation of the net present value (NPV) of a project that utilizes a Monte Carlo approach. Such a method can begin by expressing the equation for the net present value (NPV) in a probabilistic form. The probabilistic form can allow for the input variables to be treated as random variables with triangular distributions. Various equation parameters for the probabilistic NPV equation can be defined. A Monte Carlo computational algorithm can be executed that utilizes the probabilistic NPV equation and the defined equation parameters to produce multiple probabilistic NPV distributions. For each probabilistic NPV distribution, a mean value and a standard deviation can be ascertained. The mean value can represent the present value (PV) of the project and the standard deviation can represent the associated risk of the project.

### BACKGROUND OF THE INVENTION

The present invention relates to the field of capital budgeting, and, more particularly, to utilizing a Monte Carlo method to handle the uncertainty of input values when computing the net present value (NPV) for a project.

Businesses employ a variety of mathematical and statistical analysis techniques when evaluating the profitability of future projects. A common technique utilizes the calculated net present value (NPV) as a quantitative indicator of the value a project adds to the business. The formula,

$${\sum }_{t = 1}^{N} \frac{{I}_{t} - {E}_{t}}{{( 1 + r )}^{t}} - {E}_{0} ,$$

calculates the NPV of a project as the summation of the income, I, minus the expenses, E, divided by the value of one plus the rate of return, r, raised to the power of the value of the time, t, over the time period starting with one till the total time of the project, N. The value of the initial expense, E₀, of the project is then subtracted from the summation.

When the input variables for the income and expenses are known or easily ascertained, calculation of the NPV of a project offers valuable insight of the project's business value. For example, sales revenue of adding a new style of purses to a product line can be reasonably predicted from previous sales histories related to purses. The expenses of machinery, materials, and manpower are available from the project plan. Thus, the NPV for the new line of purses is calculated with relative certainty.

However, there are many projects, such as those dealing with information technology (IT) and software development, where the input variables are uncertain or are better expressed by a range of possible values. In these situations, the ability of the above formula to calculate a meaningful NPV for the project greatly diminishes. For example, the income of a new computer game is difficult to predict with certainty due to the large number of factors that often influence these sales.

### BRIEF SUMMARY OF THE INVENTION

The present invention can be implemented in accordance with numerous aspects consistent with the materials presented herein. One aspect of the present invention can include a method for handling the uncertainty of input variables in the calculation of the net present value (NPV) of a project that utilizes a Monte Carlo approach. Such a method can begin by expressing the equation for the net present value (NPV) in a probabilistic form. The input variables for the equation can have indefinite values. The probabilistic form can allow for the input variables to be treated as random variables with triangular distributions. Various equation parameters for the probabilistic form of the NPV equation can be defined. A Monte Carlo computational algorithm can be executed that utilizes the probabilistic form of the NPV equation and the defined equation parameters to produce multiple probabilistic NPV distributions. For each probabilistic NPV distribution, a mean value and a standard deviation and other statistics such as variance and mode can be ascertained. The mean value can represent the present value (PV) of the project and the standard deviation can represent the associated risk of the project, in respect to the equation parameters used for generating the probabilistic NPV distribution.

Another aspect of the present invention can include a system for handling the uncertainty of input variables in the calculation of the net present value (NPV) of a project that utilizes a Monte Carlo approach. Such a system can include a probabilistic net present value (NPV) equation and a project analysis tool. The probabilistic NPV equation can allow the input variables to be treated as random variables having triangular distributions. The project analysis tool can be configured to calculate summary statistical data using the probabilistic NPV equation in a Monte Carlo computation algorithm for defined equation parameters. The summary statistical data can be based upon multiple probabilistic NPV distributions produced by the Monte Carlo computational algorithm.

Still another aspect of the present invention can include a project analysis tool that handles the uncertainty of input variables when calculating the net present value (NPV) of a project. Such a project analysis tool can include a probabilistic net present value (NPV) equation and a Monte Carlo simulation component. The probabilistic NPV equation can be used to calculate the NPV of a project, allowing the input variables to be treated as random variables having triangular distributions. The Monte Carlo simulation component can be configured to utilize a Monte Carlo computational algorithm to calculate summary statistical data for the project using the probabilistic NPV equation.

### BRIEF DESCRIPTION OF THE SEVERAL VIEWS OF THE DRAWINGS

There are shown in the drawings, embodiments which are presently preferred, it being understood, however, that the invention is not limited to the precise arrangements and instrumentalities shown.

FIG. 1 is a flow chart of a method detailing the use of a Monte Carlo method to handle the uncertainty of input variables in the calculation of the net present value (NPV) of a project in accordance with an embodiment of the inventive arrangements disclosed herein.

FIG. 2 is a schematic diagram of a system for using a Monte Carlo method to handle the uncertainty of input variables when the calculating of the probabilistic net present value (PNPV) of a project in accordance with embodiments of the inventive arrangements disclosed herein.

FIG. 2A is a schematic diagram of an example embodiment utilizing a spreadsheet application with the Crystal Ball application in accordance with embodiments of the inventive arrangements disclosed herein.

FIG. 2B is a schematic diagram of an example embodiment utilizing the IBM RATIONAL PORTFOLIO MANAGER with a Monte Carlo component in accordance with embodiments of the inventive arrangements disclosed herein.

FIG. 3A is a collection of sample inputs for using a Monte Carlo method to calculate of the probabilistic net present value (PNPV) of a project in accordance with embodiments of the inventive arrangements disclosed herein.

FIG. 3B is a collection of example outputs for using a Monte Carlo method to calculate of the probabilistic net present value (PNPV) of a project in accordance with embodiments of the inventive arrangements disclosed herein.

### DETAILED DESCRIPTION OF THE INVENTION

The present invention discloses a solution for handling the uncertainty of input variables for calculating the net present value (NPV) of a project using a Monte Carlo method. The input variables of the conventional NPV equation can be treated as random variables having triangular distributions. Therefore, the distribution of the NPV can also be a random variable having probabilistic qualities. A Monte Carlo computational algorithm can then be applied to generate distribution of the probabilistic NPV from series of random numbers generated for the input variables according to their triangular distributions. Once the probabilistic NPV distribution is generated, summary statistical data, such as the mean value and standard deviation, can be calculated and analyzed. The use of the triangular distributions and the probabilistic NPV can be particularly beneficial for innovative projects, for which traditional cost and revenue projections needed to compute a traditional NPV have low credibility as they do account for the uncertainty of future costs and benefits (as historic value points for determining these costs and revenue projections may be non-existent or have high variation). The triangular distribution, on the other hand, represents a best understanding based on the information at hand including the uncertainty of the costs and revenue, which can be used to generate a reasonable probabilistic NPV believed to better represent the investment decision data than conventional NPV calculations.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

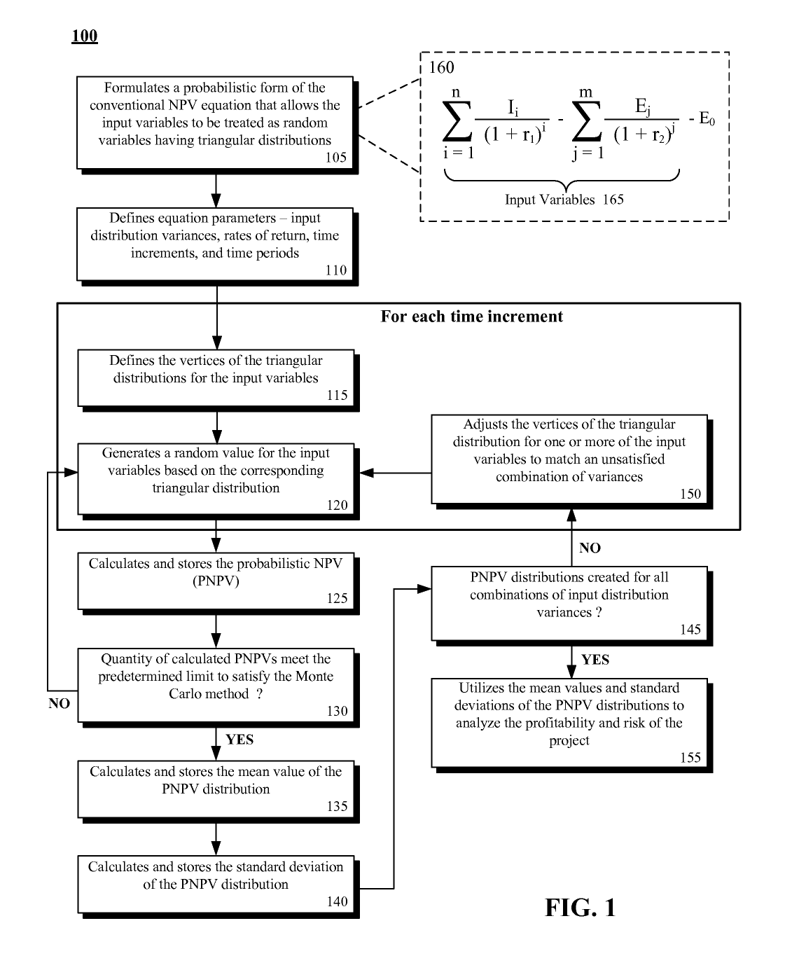

FIG. 1 is a flow chart of a method 100 detailing the use of a Monte Carlo method to handle the uncertainty of input variables 165 in the calculation of the net present value (NPV) 160 of a project in accordance with an embodiment of the inventive arrangements disclosed herein. Method 100 can be performed in the context of a system configured to utilize a Monte Carlo method to handle the uncertainty of input variables when calculating the NPV of a project.

Method 100 can begin with step 105 where a probabilistic form of the conventional equation used to calculate the NPV of a project can be formulated that allows the input variables 165 to be treated as random variables having triangular distributions. By treating the input variables 165 as random variables, the uncertainty of the values for these input variables 165 can be incorporated into the calculation of the NPV.

It is important to emphasize that the randomness of the input variables 165 are assumed to follow a triangular distribution. A triangular distribution is a continuous probability density function that is linear within the bounds of an upper limit and a mode, value and the lower limit, and a mode value. These limits can correspond to estimates for a best-case value, a worst-case value, and a likely value for the input variables 165. Additionally, the uniformity and continuous nature of the triangular distribution implies that probability of values is not irregular and that a value exists for all possibilities within the defined bounds (i.e., no holes exist).

For example, weak sales, a worst case estimate, can be set at $5000, strong sales, a best case estimate, can be set at $15000, and a likely estimate can be set at $11000, and the nature of the triangular distribution can ensure that that the random variables generated are within these limits with a uniform probability.

The execution of step 105 can result in equation 160. Unlike the conventional NPV equation, the probabilistic NPV equation 160, herein referred to as the probabilistic NPV or PNPV, can express the input variables 165 of income and expenses as separate summations. Doing so severs the relationship between the input variables 165 that is inherent within the conventional NPV equation, emphasizing the individual variability of the input variables 165.

Equation 160 can be read as the summation of the income, I, divided by the value of one plus the external rate of return, r₁, raised to the power of the time, i, over the time period starting at one through n, minus the summation of the expenses, E, divided by the value of one plus the internal rate of return, r₂, raised to the power of the time, j, over the time period starting at one through m.

The value of the initial expense, E₀, of the project, can then be subtracted from the difference of the summations. It is important to note that the initial expense, is typically considered a fixed value, and, as such, is separated from the other expense variables that are to be determined randomly. However, uncertainty in the value of the initial expense can be accounted for by including it within the expenses summation and starting the time period at zero instead of one.

In step 110, equation parameters can be defined. These equation parameters can include input distribution variances, the internal and external rates of return, the time increments, and the time periods. That is, all other non-random parameters of the equation 160. It should be noted that since the input variables 165 are being treated as random variables that it follows the practices of good statistical analysis to analyze the resultant data in terms of the combinations of the variables' variances or distribution spreads.

The vertices of the triangular distributions for the input variables 165 can be defined in step 115. In step 120, a random value for the input variables 165 can be generated based on the triangular distributions defined in step 115. It should be noted that steps 115 and 120 are performed for each time increment of the input variables 165. That is, if the expenses of the project are predicted to occur from Q1 through Q7, then a triangular distribution must be defined and a random value generated for each quarter in the time period spanning Q1 and Q7.

Once a random value has been generated for all time increments of the input variables 165, step 125 can execute where the PNPV can be calculated and stored. In step 130, it can be determined if the quantity of PNPVs calculated meets a predetermined limit that is sufficient to satisfy the Monte Carlo method and produce a PNPV distribution.

An important property of the Monte Carlo method is its slow convergence to a better approximation as the quantity of sampled data points increases. That is, the more times the PNPV is calculated, the larger the PNPV distribution and the estimation of the actual PNPV will become more accurate. A Monte Carlo method can utilize thousands of data points, typically a minimum of 5000. This property coupled with the need for random numbers can require the use of computer assistance in the implementation of method 100.

Thus, when the quantity of calculated PNPVs does not meet the predetermined limit, flow can return to step 120 to continue generating random values for the input variables 165 and calculating the PNPV.

When the quantity of calculated PNPVs meets the predetermined limit, the mean value of the PNPV distribution can be calculated and stored in step 135. The mean value of the PNPV distribution can represent the present value (PV) of the project in relation to the parameters of the PNPV distribution.

In step 140, the standard deviation of the PNPV distribution can be calculated and stored. The standard deviation of the PNPV distribution can represent the amount of risk associated with the project in regards to the parameters of the PNPV distribution. It can be determined if a PNPV distribution has been created for all combinations of the input distribution variances in step 145.

When it is determined that a PNPV distribution does not exist for all combination of input variable variances, step 150 can execute where the vertices of the triangular distribution of one or more of the input variables 165 can be adjusted to match an unsatisfied combination. It should be noted that step 150, like steps 115 and 120, is performed for each time increment. That is, the variance of the input variable 165 is applied to all of its time increments.

From step 150 the flow of method 100 can return to step 120 to produce a PNPV distribution for the new combination of input variable variances. Once a PNPV distribution is created for all combinations of the input variable variances, step 155 can execute where the mean values and standard deviations of the PNPV distributions can be used to analyze the profitability and risk of the project.

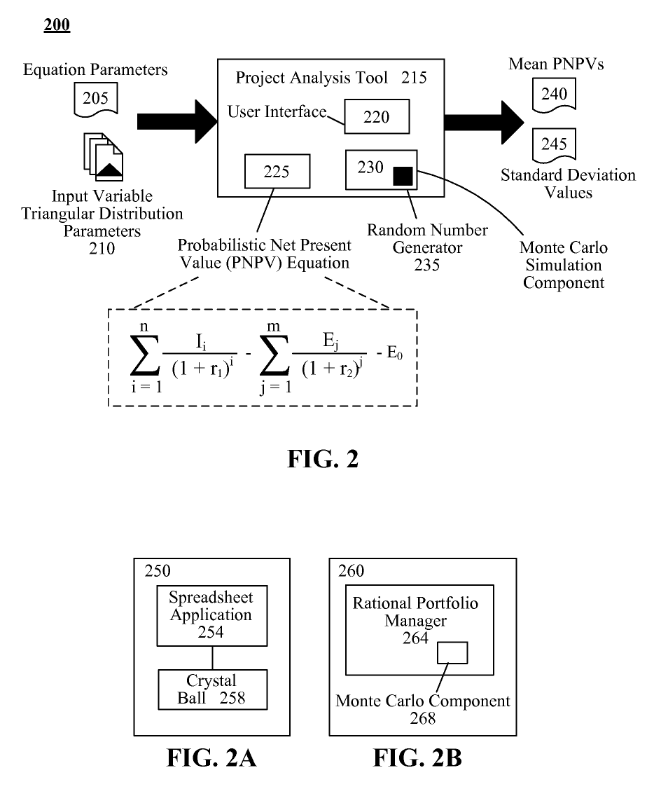

FIG. 2 is a schematic diagram of a system 200 for using a Monte Carlo method to handle the uncertainty of input variables when the calculating of the probabilistic net present value (PNPV) 235 of a project in accordance with embodiments of the inventive arrangements disclosed herein. System 200 can implement the process of method 100 or any other method utilizing a Monte Carlo approach to handle the uncertainty of input variables in the calculation of the net present value (NPV).

In system 200, a project analysis tool 215 can be configured to perform a Monte Carlo method using a PNPV equation 220 to approximate the profitability of a project having indefinite input variables. The project analysis tool 215 can represent a software application capable of utilizing the PNPV equation 225 and a Monte Carlo simulation component 230. Additionally, the project analysis tool 215 can include a user interface 220 configured to accept inputs 205 and 210 and display outputs 240 and 245.

The PNPV equation 225 can be an inherent element of the project analysis tool 215 or can be entered into the project analysis tool 215 manually by a user via the user interface 220. The user interface 220 can include automation, such as a wizard tool, to facilitate the entry of the PNPV equation 225, defining multiple incomes and/or expenses.

Inputs to the project analysis tool 215 can include equation parameters 205 and input variable triangular distribution parameters 210. These inputs 205 and 210 can be entered into the project analysis tool 215 manually or can be stored in an electronic format accessible to and readable by the project analysis tool 215.

The Monte Carlo simulation component 230 can utilize a random number generator 235 to produce random values for the input variables of the PNPV equation 225 based upon the input variable triangular distribution parameters 210 and equation parameters 205. In an alternate embodiment, the random number generator 235 can be an element of the project analysis tool 215 that can be accessed by the Monte Carlo simulation component 230.

In another embodiment, the Monte Carlo simulation component 230 can be a software application separate from and accessed by the project analysis tool 215, such as in system 250 of FIG. 2A. In system 250, the Crystal Ball application 258 can provide the Monte Carlo functionality for the spreadsheet application 254. In such an embodiment, data can be the communicated between the project analysis tool 215 and the Monte Carlo simulation component 230 via supported, standard data transfer protocols.

The Monte Carlo simulation component 230 can produce or work in conjunction with the project analysis tool 215 to produce the output data. The output data can include the calculated mean PNPV 240 and the standard deviation values 245. The output data 240 and 245, as well as any intermediary data, can be stored in a storage location (not shown) for future access.

System 260 of FIG. 2B can illustrate a specific example of system 200. In system 260, a Monte Carlo component 268 can provide Monte Carlo functionality for the IBM RATIONAL PORTFOLIO MANAGER application 264.

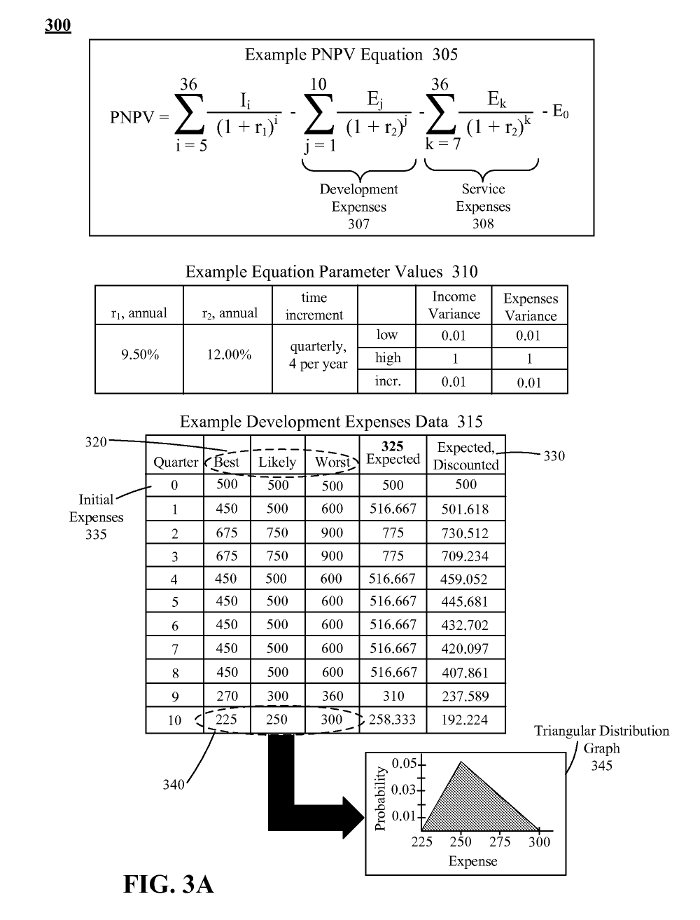

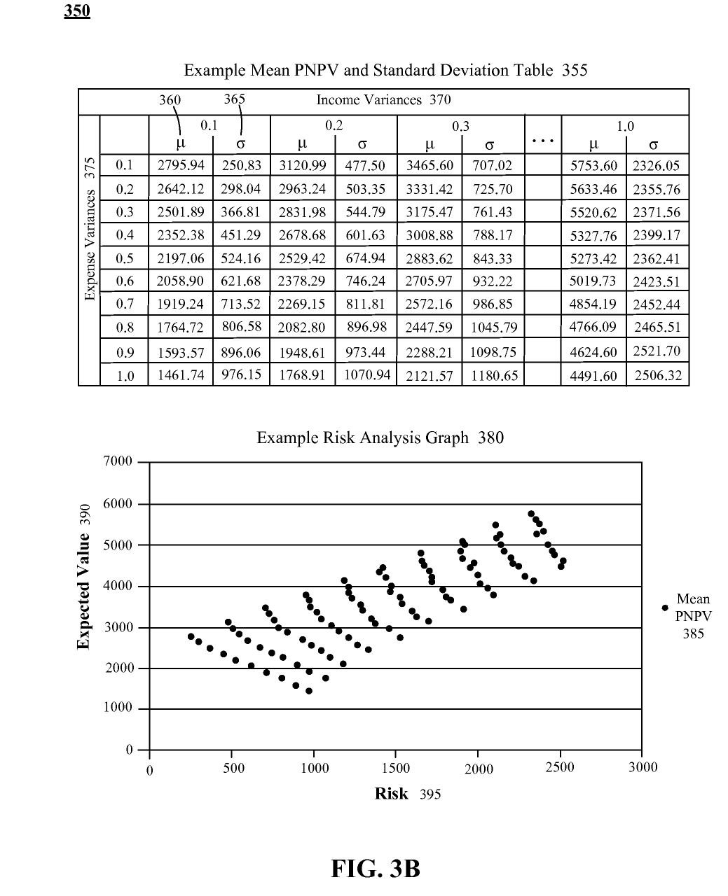

FIG. 3A is a collection 300 of example inputs for using a Monte Carlo method to calculate of the probabilistic net present value (PNPV) 305 of a project in accordance with embodiments of the inventive arrangements disclosed herein. The example inputs of collection 300 can be used in conjunction with method 100 and/or system 200.

For the purpose of illustration, the example inputs of collection 300 pertain to a project encompassing the development and deployment of a software system. As such, collection 300 can include an example PNPV equation 305, a set of example equation parameter values 310, and a set of example development expenses data 315.

The example PNPV equation 305 can be a form of equation 160 of FIG. 1 that expresses the income and expense input variables for the project. As shown in the example PNPV equation 305, the income of the project is expected to be received from time increment five through time increment thirty-six.

Further, the representation of the expenses in the example PNPV equation 305 have been broken down into two specific sub-variables—development expenses 307 and service expenses 308. In this example 305, the development expenses 397 are expected to occur from time increment one through time increment ten, while the service expenses 308 span time increment seven through thirty-six.

It is important to note how the use of multiple sub-variables within the example PNPV equation 305 allows the variability of each variable and/or sub-variable to be expressed and taken into account. That is, the variability of the development expenses 307 can be expressed without affecting the variability of the service expenses 308. The Monte Carlo method can then be applied to each sub-variable. This concept can also be applied to the income variable, if necessary.

The example equation parameter values 310 can include numeric data defining the external, r₁, and internal, r₂, rates of return, the time increment, and the distribution variances for the income and expenses. The values of the example equation parameters 310 can remain constant throughout the calculations of the PNPV distributions.

The example development expenses data 315 can contain the user-entered triangular distribution parameters 320, the random values 325 generated from the defined triangular distribution, and the discounted calculation 330 of the random value 325. Of particular note in the example development expenses data 315 is the expression of the initial expenses 330 as a constant value and without discount.

It should also be emphasized that the user-entered parameters 320 must be defined for each time increment to generate a random value 325. This mirrors the variability of the input variables over time. It should be noted that both the income and service expenses 308 would also have similar tables for their defined time periods, and that only the development expenses 307 were included for the sake of brevity and illustration.

The triangular distribution graph 345 can graphically represent the triangular distribution defined by the circled set 340 of user-entered triangular distribution parameters 325. While the creation of a triangular distribution graph 345 is not required for the calculation of the PNPV of the project, the graph 345 can be included for illustrative purposes to demonstrate the meaning of a triangular distribution.

The values of the circled set 340, best, likely, and worst, can correspond to the lower limit, upper limit, and mode value of the triangular distribution, respectively. Therefore, according to the property of the triangular distribution, the random values 325 generated by the application of the Monte Carlo method can be obtained from the shaded area of the triangular distribution graph 345.

FIG. 3B is a collection 350 of example outputs for using a Monte Carlo method to calculate of the probabilistic net present value (PNPV) of a project in accordance with embodiments of the inventive arrangements disclosed herein. The example outputs of collection 350 can be the result of the application of method 100 and/or the execution of system 200 utilizing the example inputs of collection 300.

The example outputs of collection 350 can include a table of example mean PNPV and standard deviations 355 and an example risk analysis graph 380. Table 355 can contain data for the mean PNPV 360, μ, and standard deviation 365, σ, for the various combinations of income 370 and expenses variances 375. It should be noted that the data shown in table 355 has been abridged for brevity.

The values contained for each combination of variances 370 and 375 can be calculated from a PNPV distribution whose input variables correspond to the variances 370 and 375. That is, the data shown for an income variance 370 of 0.1 and an expenses variance 375 of 0.1 can be calculated from the PNPV distribution that was generated with the triangular distributions of the income and expense input variables having a variance of 0.1.

The data of table 355 can be used to construct the example risk analysis graph 380. The example risk analysis graph 380 can graphically present the mean PNPV 385 in terms of its risk 395 versus its expected value 390. The example risk analysis graph 380 can then be used when deciding to invest in the associated project.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for handling the uncertainty of input variables in the calculation of the net present value (NPV) of a project utilizing a Monte Carlo approach comprising:
expressing an equation that calculates a net present value (NPV) of a project in a probabilistic form, wherein values for input variables of the project are indefinite, and, wherein said probabilistic form allows said input variables to be treated as random variables with triangular distributions;
defining a plurality of equation parameters for the probabilistic form of the NPV equation;
executing a Monte Carlo computational algorithm that utilizes the probabilistic form of the NPV equation with the plurality of defined equation parameters to produce a plurality of probabilistic NPV distributions; and
ascertaining for each probabilistic NPV distribution a mean value and a standard deviation, wherein the mean value represents a present value (PV) of the project and the standard deviation represents an associated risk of the project with respect to the plurality of equation parameters used for generating the probabilistic NPV distribution.

2. The method of claim 1, wherein the plurality of equation parameters comprises at least one of a distribution variance for an input variable, a rate of return, a time increment, and a time period.

3. The method of claim 1, wherein the probabilistic form of the NPV equation expresses each input variable as a summation over a time period.

4. The method of claim 3, wherein an input variable comprises a plurality of related input variables, wherein the summation of the input variable is expressed as a plurality of summations, wherein each summation within the plurality of summations corresponds to each input variable within the plurality of related input variables.

5. The method of claim 1, wherein the defining step further comprises:
specifying vertices for the triangular distribution of each input variable for each time increment, wherein said vertices comprises an upper limit, a lower limit, and a mode value.

6. The method of claim 1, wherein the executing step further comprises:
generating a series of random values for each input variable, wherein each random variable is generated according to a corresponding triangular distribution for each time increment, wherein the corresponding triangular distribution for an input variable is associated with an input variance value;
calculating the NPV using the probabilistic form of the NPV equation for the generated series of random input variable values;
storing said calculated probabilistic NPV as a data element of the probabilistic NPV distribution, wherein the probabilistic NPV distribution is identified by a unique combination of input variance values of the input variables; and
repeating the generating, calculating, and storing steps a predetermined quantity of times, wherein the predetermined quantity of times is in accordance with an application of the Monte Carlo computational algorithm.

7. The method of claim 6, further comprising:
adjusting at least one input variable by a corresponding input variance increment, wherein said adjustment is propagated through to each corresponding triangular distribution of the at least one input variable for each time increment; and
repeating the generating, calculating, storing, and adjusting steps until each unique combination of input variable variance values is associated with a corresponding probabilistic NPV distribution.

8. The method of claim 1, wherein the executing and ascertaining steps are performed by a software application configured to execute the Monte Carlo computational algorithm, wherein the probabilistic NPV equation and the plurality of equation parameters are user-entered inputs to said software application.

9. The method of claim 8, wherein the software application is a plug-in component for a project analysis application.

10. The method of claim 1, wherein said steps of claim 1 are performed by at least one machine in accordance with at least one computer program stored in a computer readable media, said computer programming having a plurality of code sections that are executable by the at least one machine.

11. A system for handling the uncertainty of input variables in the calculation of the net present value (NPV) of a project utilizing a Monte Carlo approach comprising:
a probabilistic net present value (NPV) equation for calculating a NPV of a project, wherein said probabilistic equation allows input variables to be treated as random variables having triangular distributions;
a project analysis tool configured to calculate a plurality of summary statistical data for the project by using the probabilistic NPV equation in a Monte Carlo computation algorithm for a plurality of defined equation parameters, wherein the plurality of summary statistical data is based upon a plurality of probabilistic NPV distributions produced by the Monte Carlo computational algorithm.

12. The system of claim 11, wherein the plurality of summary statistical data comprises at least one of a standard deviation of each probabilistic NPV distribution and a mean value of each probabilistic NPV distribution.

13. The system of claim 12, wherein the standard deviation represents a quantified level of risk and the mean value represents a present value (PV) associated with the plurality of defined equation parameters for each probabilistic NPV distribution.

14. The system of claim 11, wherein the probabilistic NPV equation expresses each input variable as a summation over a time period.

15. The system of claim 14, wherein an input variable comprises a plurality of related input variables, wherein the summation of the input variable is expressed as a plurality of summations, wherein each summation within the plurality of summations corresponds to each input variable within the plurality of related input variables.

16. The system of claim 11, wherein the project analysis tool comprises at least one of a spreadsheet application, a spreadsheet application with a Monte Carlo method software component, and an IBM Rational Portfolio Manager application.

17. A project analysis tool that handles the uncertainty of input variables when calculating the net present value (NPV) of a project comprising:
a probabilistic net present value (NPV) equation for calculating a NPV of a project, wherein said probabilistic NPV equation allows input variables to be treated as random variables having triangular distributions; and
a Monte Carlo simulation component configured to utilize a Monte Carlo computational algorithm to calculate a plurality of summary statistical data for the project using the probabilistic NPV equation.

18. The project analysis tool of claim 17 further comprising:
a user interface configured to accept a plurality of user-entered input parameters and display results produced by the Monte Carlo simulation component.

19. The project analysis tool of claim 18, wherein the plurality of user-entered input parameters comprises at least one of a distribution variance for an input variable, a rate of return for an input variable, a time increment, a time period, and limits for a triangular distribution of an input variable.

20. The project analysis tool of claim 17, wherein the plurality of summary statistical data comprises at least one of a standard deviation of a probabilistic NPV distribution and a mean value of a probabilistic NPV distribution, wherein the standard deviation represents a quantified level of risk and the mean value represents a present value (PV) of the project.
